(19) United States
(12) Patent Application Publication
(10) Pub. No.: US 2022/0164119 A1
(43) Pub. Date: May 26, 2022

(54) CONTROLLER, AND MEMORY SYSTEM AND DATA PROCESSING SYSTEM INCLUDING THE SAME

(71) Applicant: SK hynix Inc., gyeonggi-do (KR)

(72) Inventors: Chul Woo LEE, Gyeonggi-do (KR); Jeong Hyun KIM, Gyeonggi-do (KR); Jin Soo KIM, Gyeonggi-do (KR); Min Su SON, Gyeonggi-do (KR); Na Young LEE, Gyeonggi-do (KR)

(21) Appl. No.: 17/242,997

(22) Filed: Apr. 28, 2021

(30) Foreign Application Priority Data
Nov. 25, 2020 (KR) 10-2020-0159859

(51) Int. Cl. G06F 3/06

(52) U.S. Cl. CPC G06F 3/0631; G06F 3/0679; G06F 3/0604; G06F 3/0644

(57) ABSTRACT

Disclosed are a controller and a memory system including the controller. The memory system may include a memory device suitable for storing data and valid information of the data, and a controller suitable for allocating a logical address to write data requested by a host, based on the valid information, and notifying the host of the allocated logical address.

### CROSS-REFERENCE TO RELATED APPLICATION(S)

The present application claims priority under 35 U.S.C. § 119(a) to Korean Patent Application No. 10-2020-0159859, filed on Nov. 25, 2020, the disclosure of which is incorporated herein by reference in its entirety.

### BACKGROUND

### 1. Field

Various embodiments of the present disclosure generally relate to a controller. More particularly, the embodiments relate to a controller that allocates an address of data based on file system information, and a system including the controller.

### 2. Description of the Related Art

Recently, a paradigm for a computing environment has shifted to ubiquitous computing, which enables computer systems to be accessed virtually anytime and everywhere. As a result, the use of portable electronic devices, such as mobile phones, digital cameras, notebook computers, and the like, are rapidly increasing. Such portable electronic devices typically use or include a memory system that uses or embeds at least one memory device, i.e., a data storage device. The data storage device can be used as a main storage device or an auxiliary storage device of a portable electronic device.

Unlike a hard disk, a data storage device using a nonvolatile semiconductor memory device is advantageous in that it has excellent stability and durability because it has no mechanical driving part (e.g., a mechanical arm), and has high data access speed and low power consumption. In the context of a memory system having such advantages, a data storage device includes a universal serial bus (USB) memory device, a memory card having various interfaces, a solid state drive (SSD), or the like.

### SUMMARY

Various embodiments of the present disclosure are directed to a controller capable of optimizing a storage space of a system and reducing redundant operations by allocating an address of data and notifying a host of the allocated address based on file system information and valid information of the data, and an operating method of the controller.

In accordance with an embodiment of the present disclosure, a memory system may include: a memory device suitable for storing data and valid information of the data, and a controller suitable for allocating a logical address to write data requested by a host, based on the valid information, and notifying the host of the allocated logical address.

In accordance with an embodiment of the present disclosure, a controller may include: a memory suitable for storing disk information representing a plurality of area identifications, which identify a plurality of data areas, and a plurality of logical addresses corresponding to each of the plurality of area identifications; and a control component suitable for allocating a corresponding logical address to write data based on an area identification of the write data and the disk information.

In accordance with an embodiment of the present disclosure, a data processing system may include: a memory system; and a host suitable for providing the memory system with disk information, wherein the memory system comprises: a memory device suitable for storing data requested by the host; a memory suitable for storing the disk information and valid information of the data; and a control component suitable for allocating a corresponding logical address to the data based on the disk information and the valid information.

In accordance with an embodiment of the present disclosure, a data processing system may include: a host; and a memory system including a memory device, which includes a plurality of areas, coupled to the host and configured to: receive and store, from the host, disk information including identification information for the plurality of areas and logical block addresses (LBAs) for each area; perform one or more operations on one or more areas among the plurality of areas; update whether one or more logical block addresses among the logical block addresses are associated with valid data or invalid data, in response to the one or more operations; receive write data from the host; assign a logical block address for the write data, among logical block addresses associated with invalid data, among the logical block addresses; perform a write operation on the memory device associated with the write data; and transmit, to the host, information indicating completion of the write operation and the assigned logical block address.

### BRIEF DESCRIPTION OF THE DRAWINGS

FIG. 1 is a block diagram illustrating a data processing system including a memory system in accordance with an embodiment of the present disclosure.

FIG. 2 is a block diagram illustrating the memory system illustrated in FIG. 1.

FIG. 3 is a diagram illustrating disk information provided from a host to a memory system in accordance with an embodiment of the present disclosure.

FIG. 4 is a diagram illustrating disk information and valid information stored in a memory system in accordance with an embodiment of the present disclosure.

FIG. 5 is a diagram illustrating an operation of a controller in accordance with an embodiment of the present disclosure.

### DETAILED DESCRIPTION

Various embodiments of the present disclosure are described below with reference to the accompanying drawings, in order to describe in detail the present disclosure so that those with ordinary skill in art to which the present disclosure pertains may easily carry out the technical spirit of the present disclosure. However, the present disclosure is not limited to the embodiments disclosed below, but may be implemented in various other forms. The disclosed embodiments are provided to make the present disclosure complete and to enable those skilled in the art to practice the invention.

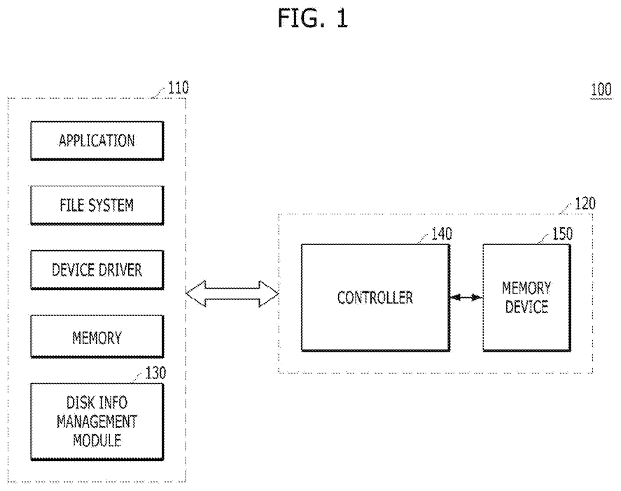

FIG. 1 is a block diagram illustrating a data processing system 100 including a memory system in accordance with an embodiment of the present disclosure. Referring to FIG. 1, the data processing system 100 may include a host 110 and a memory system 120.

For example, the host 110 may include any of various portable (i.e., wireless) electronic devices such as a mobile phone, MP3 player and laptop computer, or any of various non-portable electronic (i.e., wired) devices such as a desktop computer, a game machine, a television (TV) and a projector.

The host 120 also includes at least one operating system (OS), which can generally manage and control, functions and operations performed in the host 110. The OS can provide interoperability between the host 110 engaged with the memory system 120 and the user needing and using the memory system 120. The OS may support functions and operations corresponding to user's requests. By way of example but not limitation, the OS can be classified into a general operating system and a mobile operating system according to mobility of the host 110. The general operating system may be split into a personal operating system and an enterprise operating system according to system requirements or a user's environment. The personal operating system, including Windows and Chrome, may be subject to support services for general purposes. The enterprise operating system can be specialized for securing and supporting high performance, including Windows servers, Linux, Unix and the like. Further, the mobile operating system may include an Android, an iOS, a Windows mobile and the like. The mobile operating system may be subject to support services or functions for mobility (e.g., a power saving function). The host 110 may include a plurality of operating systems. The host 110 may execute multiple operating systems interlocked with the memory system 120, corresponding to a user's request. The host 110 may transmit a plurality of commands corresponding to the user's requests into the memory system 120, thereby performing operations corresponding to commands within the memory system 120.

According to an embodiment, the host 110 may include an application program, a file system, a device driver, a memory and a disk information management module 130.

The application program may request a write or read operation from the file system. The file system may manage, in units of files, data stored in the memory system 120. The host 110 may include a plurality of file systems. The device driver may transmit a write or read request to the memory system 120 to process the write or read operation. The memory may be used to temporarily store data in the host 110.

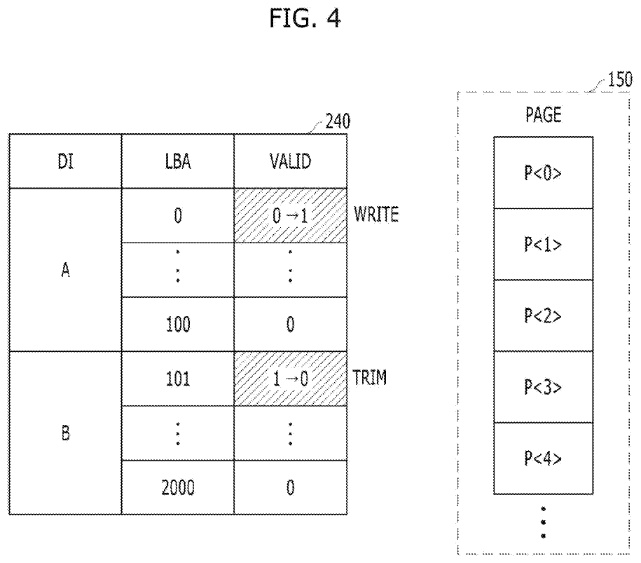

The disk information management module 130 may manage disk information about disks managed in the host 110. The host 110 according to an embodiment may provide the memory system 120 with the disk information managed by the disk information management module 130. The disk information management module 130 may manage the disk information according to partition information or file system information, and transmit the disk information to the memory system 120. The structure of the disk information is described in more detail with reference to FIGS. 3 and 4 below.

The memory system 120 may operate or perform a specific function or operation in response to a request from the host 110 and, particularly, may store data to be accessed by the host 110. The memory system 120 may be used as a main memory system or an auxiliary memory system of the host 110. The memory system 120 may be implemented with any of various types of storage devices, which may be electrically coupled with the host 110, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like.

The memory system 120 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The storage devices for the memory system 120 may be implemented with a volatile memory device, for example, a dynamic random access memory (DRAM) and a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM) and a flash memory.

Referring to FIG. 1, the memory system 120 may include a controller 140 and a memory device 150. The controller 140 may process data accessed by the host 110, and the memory device 150 may store data processed by the controller 140.

The controller 140 may control the memory device 150 in response to a request of the host 110. For example, the controller 140 may store data, provided by the host 110, in the memory device 150, and provide data read from the memory device 150 to the host 110. To this end, the controller 140 may control write, read, program, erase and background operations of the memory device 150.

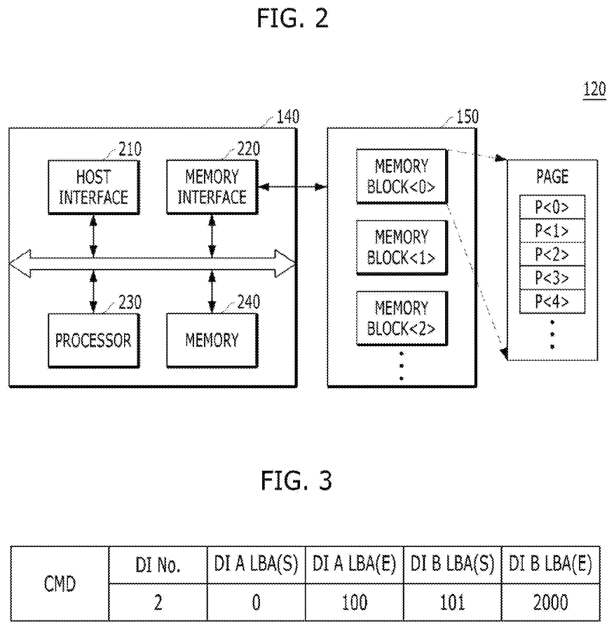

FIG. 2 is a block diagram illustrating the memory system 120 illustrated in FIG. 1.

Referring to FIG. 2, the controller 140 may include a host interface 210, a memory interface 220, a processor 230 and a memory 240. All the components 210, 220, 230 and 240 included in the controller 140 may share a signal transmitted in the inside of the controller 140 through an internal bus.

The host interface 210 may interface the host 110 and the memory system 120 in response to the protocol of the host 110. The host interface 210 may perform an operation of exchanging commands and data transmitted between the host 110 and the memory system 120.

The host interface 210 may process commands and data provided from the host 110, and may communicate with the host 110 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), small computer system interface (SCSI), enhanced small disk interface (ESDI) and integrated drive electronics (IDE). In accordance with an embodiment, the host interface 210 is a component for exchanging data with the host 110, which may be implemented through a firmware called a host interface layer (HIL).

The memory interface 220 may serve as an interface for handling commands and data transferred between the controller 140 and the memory device 150, to allow the controller 140 to control the memory device 150 in response to a request delivered from the host 110. The memory interface 220 may generate a control signal for the memory device 150 and may process data entered into or outputted from the memory device 150 under the control of the processor 230 in a case when the memory device 150 is a flash memory and, in particular, when the memory device 150 is a NAND flash memory. The memory interface 220 may provide an interface for handling commands and data between the controller 140 and the memory device 150, for example, operations of a NAND flash interface, in particular, operations between the controller 140 and the memory device 150. In accordance with an embodiment, the memory interface 220 may be implemented through firmware called a flash interface layer (FIL) as a component for exchanging data with the memory device 150.

The processor 230 may be implemented with a microprocessor or a central processing unit (CPU). The memory system 120 may include one or more processors 230. The processor 230 may control the overall operations of the memory system 120. By way of example but not limitation, the processor 230 may control a program operation or a read operation of the memory device 150, in response to a write request or a read request entered from the host 110. In accordance with an embodiment, the processor 230 may use or execute firmware to control the overall operations of the memory system 120. Herein, the firmware may be referred to as a flash translation layer (FTL). The FTL may perform an operation as an interface between the host 110 and the memory device 150. The host 110 may transmit requests for write and read operations to the memory device 150 through the FTL.

For example, when performing an operation requested from the host 110 in the memory device 150, the controller 140 uses the processor 230 implemented in a microprocessor or central processing unit (CPU) or the like. The processor 230 engaged with the memory device 150 may handle instructions or commands corresponding to an inputted command from the host 110. The controller 140 may perform a foreground operation as a command operation, corresponding to a command inputted from the host 110, such as a program operation corresponding to a write command, a read operation corresponding to a read command, an erase/discard operation corresponding to an erase/discard command and a parameter set operation corresponding to a set parameter command or a set feature command with a set command.

For another example, the controller 140 may perform a background operation on the memory device 150 through the processor 230. By way of example but not limitation, the background operation for the memory device 150 includes a garbage collection (GC) operation, a wear leveling (WL) operation, a map flush operation and a bad block management operation of checking or searching for bad blocks.

The garbage collection operation may include an operation of copying and processing data, which are stored in a random memory block among memory blocks MEMORY BLOCK<0, 1, 2, . . . > of the memory device 150, into another random memory block. The wear leveling operation may include an operation of swapping and processing stored data between the memory blocks MEMORY BLOCK<0, 1, 2, . . . > of the memory device 150. The map flush operation may include an operation of storing map data, stored in the controller 140, in the memory blocks MEMORY BLOCK<0, 1, 2, . . . > of the memory device 150. The bad block management operation may include an operation of checking and processing a bad block among the memory blocks MEMORY BLOCK<0, 1, 2, . . . > of the memory device 150.

The controller 140 may generate and manage log data through the processor 230 in response to an operation of accessing the memory blocks MEMORY BLOCK<0, 1, 2, . . . > of the memory device 150. The operation of accessing the memory blocks MEMORY BLOCK<0, 1, 2, . . . > of the memory device 150 may include a foreground operation or a background operation performed on the memory blocks MEMORY BLOCK<0, 1, 2, . . . > of the memory device 150.

The memory 240, which is a working memory of the memory system 120 and the controller 140, may store data for driving the memory system 120 and the controller 140. More specifically, when the controller 140 controls the memory device 150 in response to a request of the host 110, the memory 240 may store firmware driven by the processor 230 and data for driving the firmware, for example, metadata.

In addition, the memory 240, which is a buffer memory of the memory system 120 and the controller 140, may temporarily store write data transmitted from the host 110 to the memory device 150 and read data transmitted from the memory device 150 to the host 110. The memory 240 may include a program memory, a data memory, a write buffer/cache, a read buffer/cache, a data buffer/cache and a map buffer/cache, for storing the write and read data.

The memory 240 may be implemented with a volatile memory. The memory 240 may be implemented with a static random access memory (SRAM), a dynamic random access memory (DRAM) or both.

Although FIG. 2 illustrates that the memory 240 is included in the controller 140, the present disclosure is not limited thereto. The memory 240 may be included outside the controller 140, and the controller 140 may input and output data to the memory 240 through a separate memory interface (not illustrated).

The memory device 150 may operate as a storage medium of the memory system 120.

The memory device 150 may be a nonvolatile memory device and may retain data stored therein even while an electrical power is not supplied. The memory device 150 may store data provided from the host 110 through a write operation, while providing data stored therein to the host 110 through a read operation.

In an embodiment of the present disclosure, the memory device 150 is embodied as a nonvolatile memory such as a flash memory such as a NAND flash memory, a NOR flash memory and the like. Alternatively, the memory device 150 may be implemented by at least one of a phase change random access memory (PCRAM), a ferroelectrics random access memory (FRAM), and a spin injection magnetic memory or a spin transfer torque magnetoresistive random access memory (STT-MRAM).

The memory device 150 may include the plurality of memory blocks MEMORY BLOCK<0, 1, 2, . . . >. Each of the memory blocks MEMORY BLOCK<0, 1, 2, . . . > included in the memory device 150 may include a plurality of pages P<0, 1, 2, 3, 4, . . . >. Furthermore, although not specifically illustrated in the drawings, each of the pages P<0, 1, 2, 3, 4, . . . > may include a plurality of memory cells.

Each of the memory blocks MEMORY BLOCK<0, 1, 2, . . . > included in the memory device 150 may be classified into a single-level cell (SLC) memory block and a multi-level cell (MLC) memory block depending on the number of bits that can be stored or represented in a single memory cell included therein.

The memory device 150 may include a plurality of memory blocks. The plurality of memory blocks may be any of different types of memory blocks such as a single-level cell (SLC) memory block, a multi-level cell (MLC) memory block or the like, according to the number of bits that can be stored or represented in one memory cell.

Here, the SLC memory block includes a plurality of pages implemented by memory cells, each storing one bit of data. The SLC memory block may have high data I/O operation performance and high durability. The MLC memory block includes a plurality of pages implemented by memory cells, each storing multi-bit data (e.g., two bits or more). The MLC memory block may have larger storage capacity for the same space compared to the SLC memory block. The MLC memory block may be highly integrated in view of storage capacity. In an embodiment, the memory device 150 may be implemented with MLC memory blocks such as an MLC memory block, a triple-level cell (TLC) memory block, a quadruple-level cell (QLC) memory block and a combination thereof. The MLC memory block may include a plurality of pages implemented by memory cells, each capable of storing 2-bit data. The triple-level cell (TLC) memory block may include a plurality of pages implemented by memory cells, each capable of storing 3-bit data. The quadruple-level cell (QLC) memory block may include a plurality of pages implemented by memory cells, each capable of storing 4-bit data. In another embodiment, the memory device 150 may be implemented with a block including a plurality of pages implemented by memory cells, each capable of storing 5-bit or more bit data.

As described above, the disk information managed by the disk information management module 130 of the host 110 may be provided to the memory system 120. The controller 140 may store the disk information, transmitted by the host 110, in the memory device 150. During a write operation, the controller 140 may allocate a logical address to the write data based on the disk information, and notify the host 110 of the allocated logical address.

Specifically, the processor 230 of the controller 140, which serves as a control component (hereinafter referred to as the control component 230) that controls overall operation of the memory system 120, may store the disk information in the memory 240. The control component 230 may allocate the logical address to the write data based on the disk information stored in the memory 240. In addition, the disk information stored in the memory 240 may be backed up to the memory device 150 by the control component 230.

Hereinafter, the disk information provided by the host 110 and a structure of data stored in the memory system 120 are described in detail.

FIG. 3 illustrates a format of the disk information provided from the host 110 to the memory system 120 in accordance with an embodiment of the present disclosure. However, the present disclosure is not limited thereto, and the host 110 may provide the memory system 120 with the disk information in various formats.

In the illustrated example of FIG. 3, the host 110 may transmit the disk information to the memory system 120 together with a command CMD indicating provision of information. In some embodiments, the disk information may include the number of data areas DI No., and a first logical address DI A LBA(S) and DI B LBA(S) and a last logical address DI A LBA(E) and DI B LBA(E), which correspond to each of the data areas. That is, the first logical address DI A LBA(S) and the last logical address DI A LBA(E) are for the data area A, and the first logical address DI B LBA(S) and the last logical address DI B LBA(E) are for the data area B.

The number of data areas DI No. of the disk information represents the number of a plurality of data areas that are distinguished from one another. That is, the host 110 may distinguish the plurality of data areas depending on the number of disk partitions, types of disk partitions (e.g., a swap partition and a file system partition), a name of a file system and types of data managed by the file system (e.g., meta data and general data).

The plurality of data areas that are distinguished as above may be identified by area identifications DI, and correspond to logical addresses LBA that do not overlap with one another. By way of example, FIG. 3 illustrates the number of data areas DI No. of 2 and thus, data areas identified by area identifications DI “A” and “B”. The two data areas may correspond to logical addresses LBA “0 to 100” and “101 to 2000”, respectively.

As illustrated in FIG. 3, when the number of data areas DI No. is provided by the host 110 as the disk information, the memory system 120 may sequentially allocate the area identifications DI “A” and “B” to the respective data areas corresponding to the number of data areas DI No., and identify the data areas. However, the present disclosure is not limited thereto. Instead of the number of data areas DI No., the area identifications DI may be directly provided by the host 110 as the disk information and managed by the memory system 120.

FIG. 4 is a diagram illustrating the disk information and the valid information stored in the memory system 120 in accordance with an embodiment of the present disclosure.

Referring to FIG. 4, when the disk information is received from the host 110 together with the command CMD indicating the provision of information, the control component 230 of the controller 140 may store or update the received disk information in the memory 240. The disk information stored in the memory 240 may represent the plurality of area identifications DI for identifying the plurality of data areas and the plurality of logical addresses LBA corresponding to the plurality of area identifications DI, respectively. According to an example illustrated in FIG. 3, when the number of data areas DI No. is 2, and the disk information corresponding to the logical addresses LBA “0 to 100” and “101 to 2000” are received, the control component 230 may update and manage the disk information so that the area identification DI “A” corresponds to the data area whose logical addresses LBA are “0 to 100” and the area identification DI “B” corresponds to the data area whose logical addresses LBA are “101 to 2000”.

In addition, the control component 230 may store valid information VALID, which indicates whether data corresponding to the logical addresses LBA are valid, in the memory 240. The valid information VALID may indicate whether the data corresponding to the logical addresses LBA are stored in the memory device 150. For example, when data corresponding to the logical address LBA “0” is stored in the first page P<0> of the memory device 150, the control component 230 may set the valid information VALID of the logical address LBA “0” to a logic level “1”. On the other hand, the valid information VALID of the logical address LBA in which data is not stored in the memory device 150, for example, the logical address LBA “100”, may correspond to a logic level “0”.

According to the present embodiment, the controller 140 may transmit the valid information VALID to the host 110. When a request for the valid information VALID is received from the host 110, the controller 140 may transmit the valid information VALID to the host 110, and the transmitted valid information VALID may be backed up to the memory of the host 110.

During a data invalidation operation, the controller 140 may invalidate or delete the data stored in the memory device 150. For example, when a trim command is received from the host 110, the controller 140 may delete data, which correspond to the logical addresses LBA received together with the trim command, from the memory device 150. To this end, the controller 140 may invalidate the valid information VALID corresponding to the received logical addresses LBA, that is, update the valid information VALID to the logic level “0”. In the illustrated example of FIG. 4, when a logical address LBA “101” is received together with the trim command during the data invalidation operation, the control component 230 may update the valid information VALID of the logical address LBA “101” to the logic level “0”.

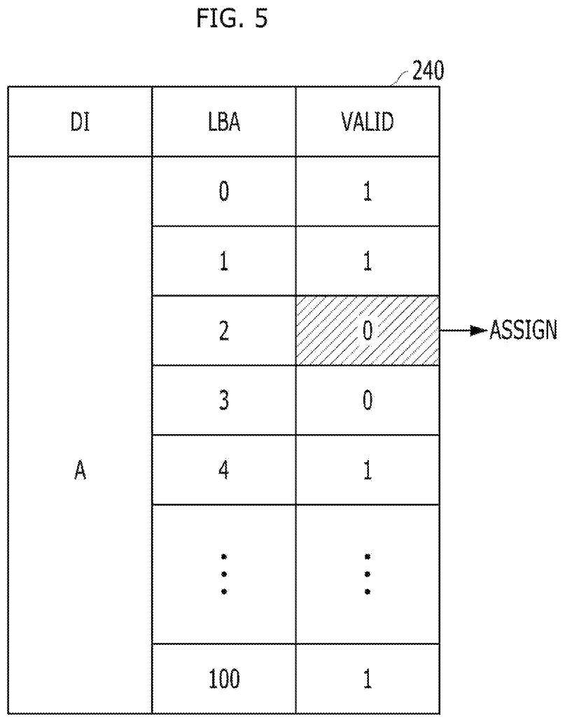

FIG. 5 is a diagram illustrating an operation of the controller 140 in accordance with an embodiment of the present disclosure. By way of example, FIG. 5 illustrates the write operation of data corresponding to the area identification DI “A”.

According to an embodiment, during the write operation, the area identification DI “A” corresponding to the write data together with the write data may be transmitted from the host 110 to the memory system 120. For example, the host 110 may transmit the area identification DI “A” to the memory system 120 while transmitting a write command indicating the write operation. Based on the transmitted area identification DI “A” and the disk information, the controller 140 of the memory system 120 may allocate the logical addresses LBA to the write data, and notify the host 110 of the allocated logical addresses LBA.

As described in the illustrated example of FIG. 5, when the area identification DI “A” is received, the control component 230 of the controller 140 may check the logical addresses LBA “0 to 100”, which correspond to the area identification DI “A”, based on the disk information stored in the memory 240. In addition, the control component 230 may allocate the logical address LBA “2” whose corresponding data is invalid, that is, valid information VALID having a logic level of “0”, among the checked logical addresses LBA “0 to 100”, to the received write data based on the valid information VALID. By way of example, FIG. 5 illustrates that the logical addresses LBA “2 and 3” whose valid information VALID has a logic level “0” are sequentially allocated to the write data, and a smaller logical address LBA “2” is allocated to the write data. However, the present disclosure is not limited thereto, and any one of the logical addresses LBA “2 and 3” whose valid information VALID has the logic level “0” may be randomly allocated to the write data.

After the write operation, the controller 140 may transmit information, which indicate whether the write operation is completely performed, to the host 110. In some embodiments, the controller 140 may transmit the logical address LBA “2”, which is allocated (or assigned) to the write data, to the host 110 together with the information indicating whether the write operation is completely performed.

According to the present embodiment, the controller 140 may substitute and perform operations performed by the host 110 for operating a file system, by using information managed for the background operation of the memory device 140. For example, the data stored in the memory device 140 may be invalidated through a trim operation, and the controller 140 may manage invalidated or valid data using a bitmap table to perform the background operation such as the garbage collection operation. The controller 140 may allocate invalidated, that is, usable logical addresses to data requested to the host 110 using the bitmap table, and notify the host 110 of the allocated logical addresses. Therefore, the host 110 may not need to separately manage the logical addresses, and may request the write operation without logical addresses. Consequently, overhead and storage space of the host 110 may be reduced.

According to an embodiment of the present disclosure, a controller may substitute and perform operations performed by a host for operating a file system, by using information managed for a background operation of a memory device, together with file system information. Therefore, it is possible to reduce overhead of the host and optimize space used in the system. In addition, the controller may perform the operations for operating the file system, based on improved performance through configurations of a circuit implemented in a memory device in a hardware manner.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods herein.

When implemented in at least partially in software, the controllers, processors, devices, modules, units, multiplexers, generators, logic, managers, interfaces, decoders, drivers, generators and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

While the present disclosure has been specifically described with reference to various embodiments, it should be noted that the disclosed embodiments are provided for illustrative purposes, not restrictive purposes. For example, although the disclosed embodiments describe that a controller manages a bad block of a memory device, a plurality of memory blocks may be designated as bad blocks through a control logic included in the memory device.

Further, those skilled in the art will understand that various embodiments are possible through various substitutions, changes, and modifications within the scope of the present disclosure. Although various embodiments of the disclosed technology have been described with particular specifics and varying details for illustrative purposes, those skilled in the art will appreciate that various modifications, additions and substitutions may be made without departing from the spirit and scope of the disclosure as defined in the following claims.

What is claimed is:

1. A memory system comprising:
a memory device suitable for storing data and valid information of the data; and
a controller suitable for allocating a logical address to write data requested by a host based on the valid information, and notifying the host of the allocated logical address.

2. The memory system of claim 1, wherein the memory device stores disk information representing a plurality of area identifications which identify a plurality of data areas, and a plurality of logical addresses corresponding to each of the plurality of area identifications.

3. The memory system of claim 2, wherein an area identification corresponding to the write data among the plurality of area identifications is received from the host during a write operation.

4. The memory system of claim 3, wherein after the write operation, the controller transmits the allocated logical address to the host together with information indicating whether the write operation is completely performed.

5. The memory system of claim 3, wherein the valid information indicates whether data corresponding to the plurality of logical addresses are valid.

6. The memory system of claim 5, wherein the controller checks logical addresses, which correspond to an area identification transmitted by the host based on the disk information, and allocates a logical address which corresponds to invalid data among the checked logical addresses, to the write data based on the valid information.

7. The memory system of claim 5, wherein the controller transmits the valid information to the host according to a request of the host.

8. The memory system of claim 5, wherein during a data invalidation operation, the controller receives a logical address from the host, and invalidates valid information corresponding to the received logical address.

9. The memory system of claim 2, wherein the number of the plurality of data areas, and first and last logical addresses corresponding to each of the plurality of data areas are received as the disk information from the host.

10. The memory system of claim 2, wherein the plurality of data areas are distinguished depending on partition information or file system information.

11. A controller comprising:
a memory suitable for storing disk information representing a plurality of area identifications which identify a plurality of data areas, and a plurality of logical addresses corresponding to each of the plurality of area identifications; and
a control component suitable for allocating a corresponding logical address to write data based on an area identification of the write data and the disk information.

12. The controller of claim 11, wherein the control component receives the area identification of the write data from a host during a write operation, and transmits the allocated logical address to the host together with information indicating whether the write operation is completely performed.

13. The controller of claim 11, wherein the memory stores valid information indicating whether data corresponding to the plurality of logical addresses are valid.

14. The controller of claim 13, wherein the control component checks logical addresses, which correspond to the area identification of the write data based on the disk information, and allocates a logical address which corresponds to invalid data among the checked logical addresses, to the write data based on the valid information.

15. The controller of claim 13, wherein the control component transmits the valid information to the host according to a request of a host.

16. The controller of claim 13, wherein the control component invalidates valid information corresponding to the received logical address in response to a logical address received during a data invalidation operation.

17. The controller of claim 11, wherein the number of the plurality of data areas, and first and last logical addresses corresponding to each of the plurality of data areas are received as the disk information from a host.

18. The controller of claim 11, wherein the plurality of data areas are distinguished depending on partition information or file system information.

19. A data processing system comprising:
a memory system; and
a host suitable for providing the memory system with disk information,
wherein the memory system comprises:
a memory device suitable for storing data requested by the host;
a memory suitable for storing the disk information and valid information of the data; and
a control component suitable for allocating a corresponding logical address to the data based on the disk information and the valid information.

20. The data processing system of claim 19, wherein the host comprises a disk information management module suitable for managing the disk information according to partition information or file system information, and transmitting the disk information to the memory system.
